(19) United States
(12) Patent Application Publication
(10) Pub. No.: US 2012/0316929 A1
(43) Pub. Date: Dec. 13, 2012

(54) SYSTEMS AND METHODS FOR PROVIDING RENTAL VALUATION DATA

(76) Inventor: Donald GILBERT, Mt. Gravatt (AU)

(21) Appl. No.: 13/492,699

(22) Filed: Jun. 8, 2012

(30) Foreign Application Priority Data
Jun. 10, 2011 (AU) 2011202797

(51) Int. Cl. G06Q 10/00

(52) U.S. Cl. 705/7.38

(57) ABSTRACT

Described herein are systems and methods for providing rental valuation data (for example in terms of indicative market rental values). For example, such data may be used to define a suggested reasonable rental value, or indicate whether a proposed rental amount is higher or lower than objective factors would suggest. This is focused on a property to be rented by a business operator from a landlord, to renew a lease or to settle a rental dispute.

### FIELD OF THE INVENTION

The present invention relates to systems and methods for providing rental valuation data. Embodiments of the invention have been particularly developed for allowing a user to input various parameters, and based on those receive data concerning an estimated market valuation for rental of a property. For example, this may assists with assessing current market rent and assessing “reasonable rent” to settle disputes that may arise during rental negotiations. While some embodiments will be described herein with particular reference to that application, it will be appreciated that the invention is not limited to such a field of use, and is applicable in broader contexts.

### BACKGROUND

Any discussion of the background art throughout the specification should in no way be considered as an admission that such art is widely known or forms part of common general knowledge in the field.

Determining an appropriate rental price is crucial in the context of substantially all rental transactions. One approach is to use a market rental valuation as guidance, but unfortunately known methods for deriving a market rental valuation are unreliable. Market rent is important if not crucial in establishing better and more accurate market valuations. There is a need in the art for improved systems and methods for improved systems and methods for providing rental valuation data.

### SUMMARY OF THE INVENTION

It is an object of the present invention to overcome or ameliorate at least one of the disadvantages of the prior art, or to provide a useful alternative.

One embodiment provides a computer implemented method for providing rental valuation data for a property to be rented by a business operator from a landlord, the method including:

accepting input of first data indicative of the reasonableness of the business operator;

processing the first data thereby to define an operator reasonableness score;

accepting input of second data indicative of past performance of the business operator;

accepting input of third data indicative of performance of one or more comparison benchmarks;

processing the second data and third data thereby to define an operator performance comparison score;

accepting input of fourth data indicative of rental data for one or more comparison businesses;

processing the fourth data thereby to define a rental range;

determining a position in the rental range appropriate for the property to be rented by the business operator from the landlord based on the operator reasonableness score and operator performance comparison score.

One embodiment provides a computer implemented method for providing rental valuation data for a property to be rented by a business operator from a landlord, the method including:

(a) accepting as input data indicative of historical business performance of the operator at the property;

(b) accepting as input data indicative of the historical business performance of the operator at one or more other properties;

(c) in the case that the historical business performance of the operator at the property is better than the historical business performance of the operator at one or more other properties, defining a parameter favourable to a higher valuation; and

(d) in the case that the historical business performance of the operator at the property is worse than the historical business performance of the operator at one or more other properties, defining a parameter favourable to a lower valuation.

One embodiment provides a computer implemented method for providing feasibility data for a property to be rented by a business operator from a landlord, the method including:

accepting input of first data indicative of the predicted reasonableness of the business operator;

processing the first data thereby to define an operator reasonableness score;

accepting input of second data indicative of predicted performance of the business operator;

accepting input of third data indicative of performance of one or more comparison benchmarks;

processing the second data and third data thereby to define an operator performance comparison score;

accepting input of fourth data indicative of proposed rental costs for the property;

determining a relationship between the proposed rental costs and a feasible range appropriate for the property to be rented by the business operator from the landlord based on the operator reasonableness score and operator performance comparison score.

One embodiment provides a computer program product for performing a method as described herein.

One embodiment provides a non-transitive carrier medium for carrying computer executable code that, when executed on a processor, causes the processor to perform a method as described herein.

One embodiment provides a system configured for performing a method as described herein.

Reference throughout this specification to “one embodiment”, “some embodiments” or “an embodiment” means that a particular feature, structure or characteristic described in connection with the embodiment is included in at least one embodiment of the present invention. Thus, appearances of the phrases “in one embodiment”, “in some embodiments” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

### BRIEF DESCRIPTION OF THE DRAWINGS

Embodiments of the invention will now be described, by way of example only, with reference to the accompanying drawings in which:

FIG. 1 schematically illustrates a method according to one embodiment;

FIG. 2A to FIG. 2C illustrate exemplary graphs according to embodiments.

FIG. 3 illustrates a web-delivery implementation according to one embodiment.

### DETAILED DESCRIPTION

Described herein are systems and methods for providing rental valuation data (for example in terms of indicative market rental values). For example, such data may be used to define a suggested reasonable rental value, or indicate whether a proposed rental amount is higher or lower than objective factors would suggest. This is focused on a property to be rented by a business operator from a landlord, to renew a lease or to settle a rental dispute.

In the examples considered herein, it is assumed that the business operator is already conducting business at the property (to reasonable industry standards), and in some cases additionally conducts (or has conducted) business at other properties. However, it will be recognized how the methodologies herein are modified in circumstances where either or both of these factors do not apply.

Various embodiments use data indicative of businesses. This data may include any one or more of turnover, profits, sales, type of business, business location, floor area of tenanted property, rental charges, and optionally other forms of data.

### Exemplary Methodology for Valuations

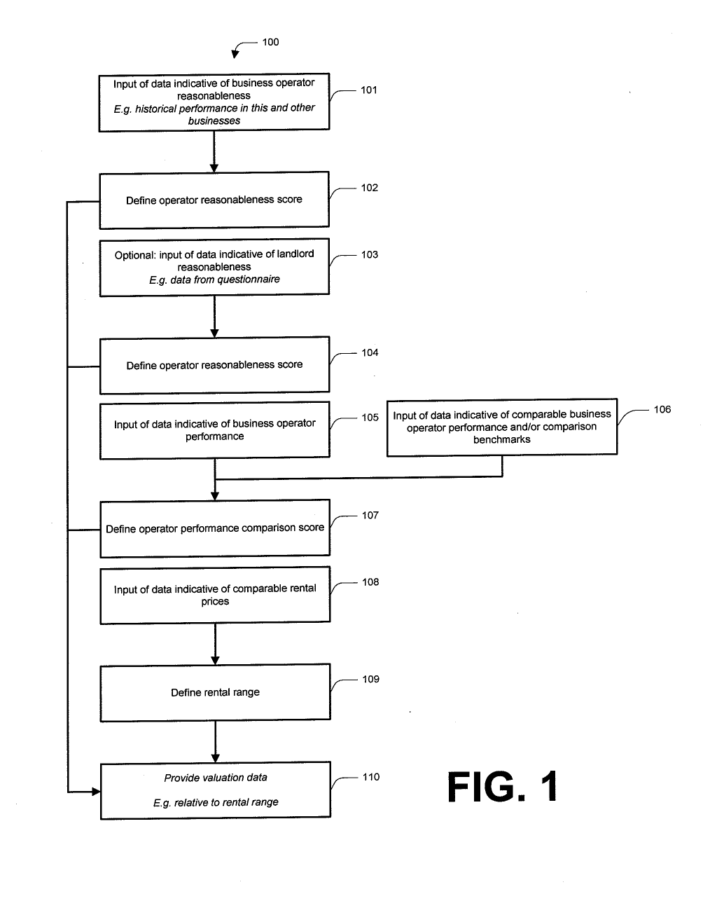

FIG. 1 illustrates an exemplary method 100. This method is in some embodiments a computer implemented method. That is, the method is performed on the basis of software instructions (i.e. computer readable code) stored on a storage medium and executed via one or more processors of a computer system.

For various steps herein, data is accepted. Where relevant, this data is normalised using one or more normalising parameters, such as floorspace (for example in square meters) or reasonable annual rent relative to reasonable site performance, evaluation of comparable evidence, industry benchmarks and so on. For example, rental price is normalized as rental price/square meter, turnover is normalized as turnover/square meter, and on an annualized sum basis for ranking and comparison purposes, and so on.

Functional block 101 represents a process including accepting input of first data indicative of the reasonableness of the business operator. In one embodiment, this includes data indicative of the historical performance of the business operator at the property (for example based on turnover/square meter and/or KPIs extracted from accounting records), and data indicative of historical performance of the business operator at one or more other properties (also for example based on turnover/square meter and/or KPIs extracted from accounting records, even over a series of time periods). This processed at 102 thereby to define an operator reasonableness score. In particular, the performance of the operator at that and other properties is compared thereby to determine whether:
Performance is approximately the same; and hence the property does not have a discernable impact on performance. This results in a neutral reasonableness score.
Performance is better at the property; and hence the property has a positive impact on performance. This results in a reasonableness score favorable to upwardly swinging valuation.
Performance is worse at the property; and hence the property has a negative impact on performance. This results in a reasonableness score favorable to downwardly swinging valuation.

In other embodiments alternate approaches are used for assessing the reasonableness of the operator.

Functional block 103 includes accepting input indicative of the reasonableness of the landlord. This data is in some embodiments indicative of the performance of a retail centre including the property, and/or one or more other businesses in the retail centre, relative to a set of benchmarks. In some embodiments this includes data derived from a questionnaire completed via a site inspection. The data is processed at 104 thereby to define a landlord reasonableness score. The essence is to establish whether there are any factors specific to the retail centre and/or property that would be favorable to upwardly or downwardly swinging valuation. In some embodiments blocks 103 and 104 are excluded.

Functional block 105 represents a process including accepting input of data indicative of past performance of the business operator, and functional block 106 represents a process including accepting input of third data indicative of performance of one or more comparison benchmarks. The comparison benchmarks may include predefined comparison benchmarks and/or comparison benchmarks based on data indicative of the performance of one or more comparison business similar to the business of the business operator. For example, these may be similar in the context of any one or more of category of business (e.g. fashion, food, department store, etc), location of business (metro, regional, etc), and characteristics of the retail centre (metro, regional, age, etc). The data accepted at 105 and 106 is processed at 107 thereby to define an operator performance comparison score. In some embodiments this comparison score reflects whether there are factors that make the business of the business operator particularly lucrative comparison to benchmarks and/or other businesses. The comparison score affects upward/downward valuation swings. In some embodiments this is applied in a manner that distinguishes between performance due to characteristics of the business operator and characteristics of the property. For example, if all businesses in a retail center (including that under consideration) are performing above benchmarks and/or those of other centers, that should result in an upward swing (as the centre has additional value add aspects). On the other hand, if businesses in a retail center other than that under consideration are performing at comparable levels, but that under consideration is performing far better, that should not result in an upward swing (as it is the business operator rather than the center driving high performance, for example due to ingenuity or otherwise good practices).

Functional block 108 represents a process including accepting input of data indicative of rental data for one or more comparison businesses. Once again, the comparison business may be similar to the business of the business operator in terms of category of business, location of business, and/or characteristics of the retail centre. This data is processed at 109 thereby to define a rental range. This rental range is indicative of what other comparable business are paying. In some embodiments this rental range is displayed (numerically and/or graphically), optionally in combination with proposed rental value amounts put forward by the landlord. Where data is displayed graphically, the graphical data is preferably automatically ranked and color coded for comparison purposes (for example thereby to link like forms of comparison).

Functional block 110 represents a process including determining a position in the rental range appropriate for the property to be rented by the business operator from the landlord based on the operator reasonableness score, landlord reasonableness score (if defined) and operator performance comparison score. This position in the rental range may be defined by a range, for example a suggested region in the range that would be appropriate based on the data collected and processed. For example, the operator reasonableness score and operator performance comparison score may swing the valuation upwardly or downwardly in the range.

In some embodiments the rental range is defined in accordance with a plurality of dimensions. For example, these dimensions are defined in terms of any one or more of rent per square meter, rent as an annual sum, and/or rent as a percentage of sales (or turnover).

Although embodiments discussed wherein focus primarily on rent per square meter, in some cases calculations are performed thereby to present rental value to a user in terms of a total annual cost (based on the size of a property). That is, rental values are in a way “de-normalized” thereby to assist in understanding total costs.

In some embodiments the rental range is defined by data renderable as one or more charts, and in some such embodiments the rental range is displayed relative to the one or more graphs. In some cases, the graphs are used to provide context to a valuation. For example, graphs may show:
In terms of operator reasonableness, discrepancies between operation at the property and elsewhere.
In terms of performance, relationships between the operator's performance, other operators' performance, and benchmarks.
In terms of rent, the spread of rental prices for comparable businesses (using varying dimensions, as discussed above), optionally in combination with landlord proposed prices and/or tenant proposed prices.

From this, it is possible to gain a rough graphical indication of where in the rental; price range the operator's rental price should be placed.

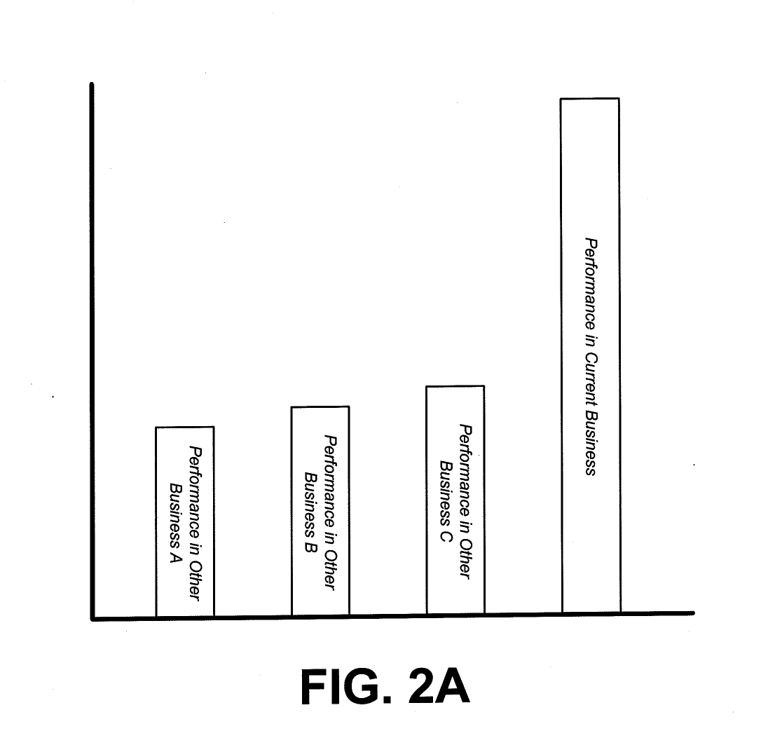

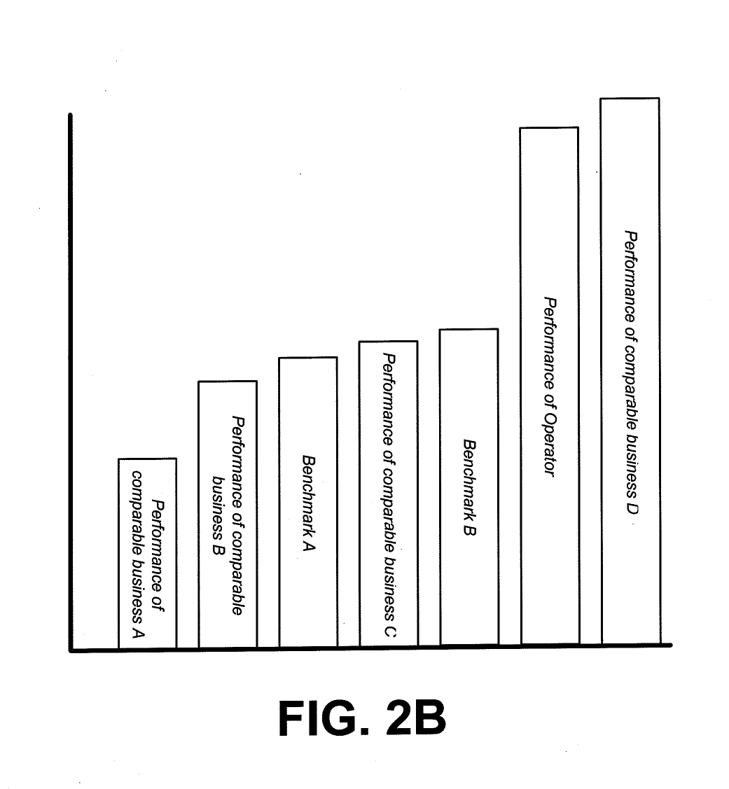

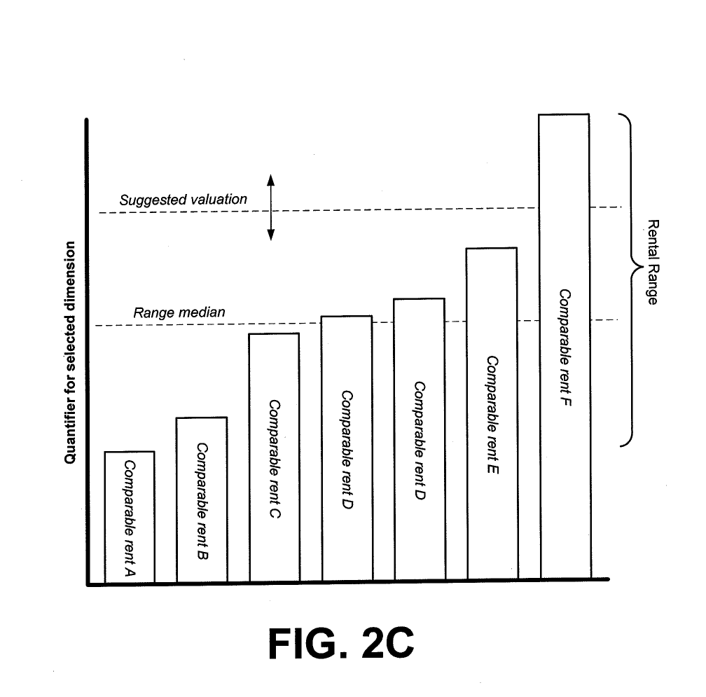

As a hypothetical example, FIG. 2A provides a graph relating to operator reasonableness (for example average annual turnover per square meter, adjusted for growth and business age). This graph clearly shows that the operator is performing better in the current location than others. FIG. 2B provides a graph showing performance compared to other businesses and benchmarks, and shows that the operator is at the upper end of the spectrum in terms of performance. FIG. 2C shows rental data for other businesses measured based on a selected dimension. The results of graphs in FIG. 2A and FIG. 2B provide operator reasonableness scores and performance comparison scores which each upwardly swing valuation, and hence the suggested valuation range is above the median of the graph of FIG. 2C.

It will be appreciated that FIG. 2A to FIG. 2C provide a relatively simple example for the purposes of explanation. Various embodiments make use of more sophisticated analysis techniques and data sets.

### Extension of Methodology to Other Purposes

The methodology and overall framework discussed above is readily modified for other purposes. For example, although the examples above are focssed on collecting values for a range of parameters thereby to assess rental valuations, an alternate approach is to set rental as a fixed value and work backwards through the method thereby to assess the appropriateness of other parameter values.

In overview, the present methodologies in essence use a model that includes some of all of the following parameters:
Operator reasonableness.
Operator performance.
Operator comparative performance.
Landlord reasonableness.
Rental data.

The methodologies above are focused on assessing rental data based on the other parameters. However, alternate embodiments use existing (i.e. fixed) rental data thereby to assess one of the other parameters.

A prime example is that of business feasibility studies. To perform such a study, rental is set at a defined value (for example based on a proposed lease agreement from a landlord), and the overall framework used to determine whether hypothetical data indicative of operator performance renders that lease appropriate in the circumstances. For example, amortizing business setup costs over the lifetime of a proposed lease, and feeding that information into expected operator performance provides valuable insight in terms of whether a business is feasible based on that hypothetical performance and lease.

In one embodiment, a feasibility study is conducted by inputting predicted information regarding a hypothetical business, performing a method based of FIG. 1, and comparing the end results with a proposed “on the table” rental value. From there, it is possible to establish the feasibility of a the business based on the predicted information and proposed rental value, and re-perform the method with adjusted parameters (for example reducing predicted costs, altering predicted turnover, and so on) thereby to gain an understanding of which hypothetical factors affect the feasibility of a proposed business.

Other embodiments are used for valuing leases (at a balance sheet level). In this regard, it should be recognized that a lease value (based on an objective methodology such as herein described) is able to be used in terms of establishing intangible in some circumstances. Increasing rent may have an effect of devaluing a lease as an intangible asset; the detrimental effect on a landlord may in some cases counteract benefits associated with higher rent. Hence, methodologies such as those herein described are readily applied for better understanding asset-related ramifications of rental adjustments.

Further embodiments are used in the context of scheduling market reviews in a lease. For example, a lease may be agreed upon with conditions requiring periodic market review of rental charges based on objective analysis using a methodology as described further above. That way, an initial rental value can be modified based on actual events, thereby to reduce risk on both operator and landlord. For example, if the business operator has poor performance as a result of the retail center, rent may decrease upon review, encouraging the landlord to improve factors thereby to allow for increased rent at a subsequent review.

### Exemplary Web Implementation

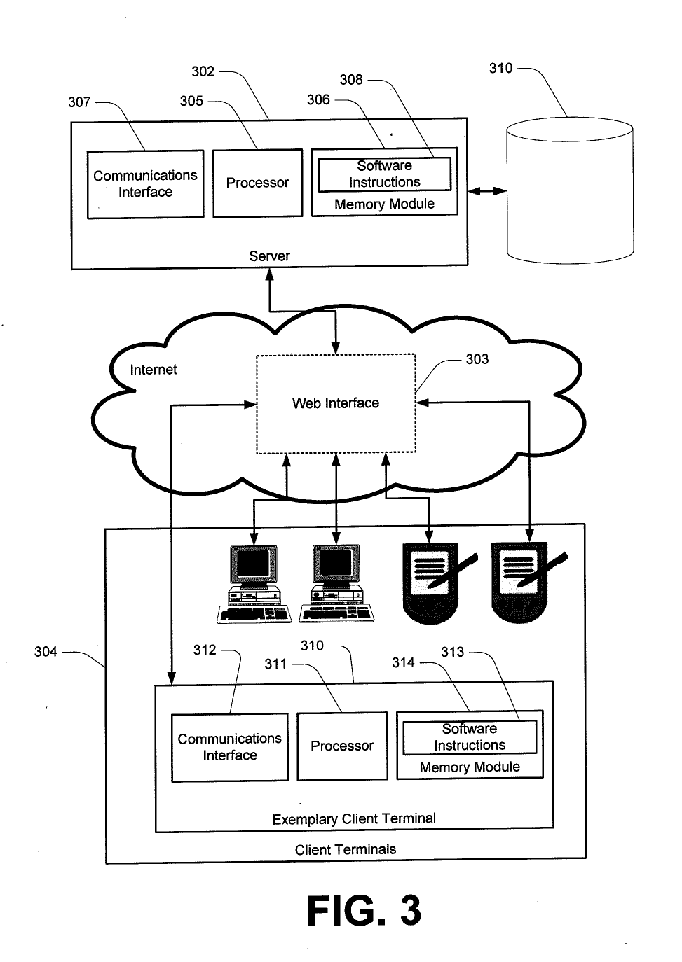

In some embodiments, methods and functionalities considered herein are implemented by way of a server, as illustrated in FIG. 3. In overview, a web server 302 provides a web interface 303. This web interface is accessed by the parties by way of client terminals 304. In overview, users access interface 303 over the Internet by way of client terminals 304, which in various embodiments include the likes of personal computers, PDAs, cellular telephones, gaming consoles, and other Internet enabled devices.

Server 303 includes a processor 305 coupled to a memory module 306 and a communications interface 307, such as an Internet connection, modem, Ethernet port, wireless network card, serial port, or the like. In other embodiments distributed resources are used. For example, in one embodiment server 302 includes a plurality of distributed servers having respective storage, processing and communications resources. Memory module 306 includes software instructions 308, which are executable on processor 305.

Server 302 is coupled to a database 310. In further embodiments the database leverages memory module 306.

In some embodiments web interface 303 includes a website. The term “website” should be read broadly to cover substantially any source of information accessible over the Internet or another communications network (such as WAN, LAN or WLAN) via a browser application running on a client terminal. In some embodiments, a website is a source of information made available by a server and accessible over the Internet by a web-browser application running on a client terminal. The web-browser application downloads code, such as HTML code, from the server. This code is executable through the web-browser on the client terminal for providing a graphical and often interactive representation of the website on the client terminal. By way of the web-browser application, a user of the client terminal is able to navigate between and throughout various web pages provided by the website, and access various functionalities that are provided.

Although some embodiments make use of a website/browser-based implementation, in other embodiments proprietary software methods are implemented as an alternative. For example, in such embodiments client terminals 304 maintain software instructions for a computer program product that essentially provides access to a portal via which framework 100 is accessed (for instance via an iPhone app or the like).

In general terms, each terminal 304 includes a processor 311 coupled to a memory module 313 and a communications interface 312, such as an internet connection, modem, Ethernet port, serial port, or the like. Memory module 313 includes software instructions 314, which are executable on processor 311. These software instructions allow terminal 304 to execute a software application, such as a proprietary application or web browser application and thereby render on-screen a user interface and allow communication with server 302. This user interface allows for the creation, viewing and administration of profiles, access to the internal communications interface, and various other functionalities.

### Conclusions and Interpretation

It will be appreciated that the disclosure above provides various significant systems and methods for providing rental valuation data.

Unless specifically stated otherwise, as apparent from the following discussions, it is appreciated that throughout the specification discussions utilizing terms such as “processing,” “computing,” “calculating,” “determining”, analyzing” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer” or a “computing machine” or a “computing platform” may include one or more processors.

The methodologies described herein are, in one embodiment, performable by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken are included. Thus, one example is a typical processing system that includes one or more processors. Each processor may include one or more of a CPU, a graphics processing unit, and a programmable DSP unit. The processing system further may include a memory subsystem including main RAM and/or a static RAM, and/or ROM. A bus subsystem may be included for communicating between the components. The processing system further may be a distributed processing system with processors coupled by a network. If the processing system requires a display, such a display may be included, e.g., a liquid crystal display (LCD) or a cathode ray tube (CRT) display. If manual data entry is required, the processing system also includes an input device such as one or more of an alphanumeric input unit such as a keyboard, a pointing control device such as a mouse, and so forth. The term memory unit as used herein, if clear from the context and unless explicitly stated otherwise, also encompasses a storage system such as a disk drive unit. The processing system in some configurations may include a sound output device, and a network interface device. The memory subsystem thus includes a computer-readable carrier medium that carries computer-readable code (e.g., software) including a set of instructions to cause performing, when executed by one or more processors, one of more of the methods described herein. Note that when the method includes several elements, e.g., several steps, no ordering of such elements is implied, unless specifically stated. The software may reside in the hard disk, or may also reside, completely or at least partially, within the RAM and/or within the processor during execution thereof by the computer system. Thus, the memory and the processor also constitute computer-readable carrier medium carrying computer-readable code.

Furthermore, a computer-readable carrier medium may form, or be included in a computer program product.

In alternative embodiments, the one or more processors operate as a standalone device or may be connected, e.g., networked to other processor(s), in a networked deployment, the one or more processors may operate in the capacity of a server or a user machine in server-user network environment, or as a peer machine in a peer-to-peer or distributed network environment. The one or more processors may form a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine.

Note that while diagrams only show a single processor and a single memory that carries the computer-readable code, those in the art will understand that many of the components described above are included, but not explicitly shown or described in order not to obscure the inventive aspect. For example, while only a single machine is illustrated, the term “machine” shall also be taken to include any collection of machines that individually or jointly execute a set (or multiple sets) of instructions to perform any one or more of the methodologies discussed herein.

Thus, one embodiment of each of the methods described herein is in the form of a computer-readable carrier medium carrying a set of instructions, e.g., a computer program that is for execution on one or more processors, e.g., one or more processors that are part of web server arrangement. Thus, as will be appreciated by those skilled in the art, embodiments of the present invention may be embodied as a method, an apparatus such as a special purpose apparatus, an apparatus such as a data processing system, or a computer-readable carrier medium, e.g., a computer program product. The computer-readable carrier medium carries computer readable code including a set of instructions that when executed on one or more processors cause the processor or processors to implement a method. Accordingly, aspects of the present invention may take the form of a method, an entirely hardware embodiment, an entirely software embodiment or an embodiment combining software and hardware aspects. Furthermore, the present invention may take the form of carrier medium (e.g., a computer program product on a computer-readable storage medium) carrying computer-readable program code embodied in the medium.

The software may further be transmitted or received over a network via a network interface device. While the carrier medium is shown in an exemplary embodiment to be a single medium, the term “carrier medium” should be taken to include a single medium or multiple media (e.g., a centralized or distributed database, and/or associated caches and servers) that store the one or more sets of instructions. The term “carrier medium” shall also be taken to include any medium that is capable of storing, encoding or carrying a set of instructions for execution by one or more of the processors and that cause the one or more processors to perform any one or more of the methodologies of the present invention. A carrier medium may take many forms, including but not limited to, non-volatile media, volatile media, and transmission media. Non-volatile media includes, for example, optical, magnetic disks, and magneto-optical disks. Volatile media includes dynamic memory, such as main memory. Transmission media includes coaxial cables, copper wire and fiber optics, including the wires that comprise a bus subsystem. Transmission media also may also take the form of acoustic or light waves, such as those generated during radio wave and infrared data communications. For example, the term “carrier medium” shall accordingly be taken to included, but not be limited to, solid-state memories, a computer product embodied in optical and magnetic media; a medium bearing a propagated signal detectable by at least one processor of one or more processors and representing a set of instructions that, when executed, implement a method; and a transmission medium in a network bearing a propagated signal detectable by at least one processor of the one or more processors and representing the set of instructions.

It will be understood that the steps of methods discussed are performed in one embodiment by an appropriate processor (or processors) of a processing (i.e., computer) system executing instructions (computer-readable code) stored in storage. It will also be understood that the invention is not limited to any particular implementation or programming technique and that the invention may be implemented using any appropriate techniques for implementing the functionality described herein. The invention is not limited to any particular programming language or operating system.

It should be appreciated that in the above description of exemplary embodiments of the invention, various features of the invention are sometimes grouped together in a single embodiment, FIG., or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

Similarly, it is to be noticed that the term coupled, when used in the claims, should not be interpreted as being limited to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Thus, while there has been described what are believed to be the preferred embodiments of the invention, those skilled in the art will recognize that other and further modifications may be made thereto without departing from the spirit of the invention, and it is intended to claim all such changes and modifications as falling within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

The claims defining the invention are as follows:

1. A computer implemented method for providing rental valuation data for a property to be rented by a business operator from a landlord, the method including:
accepting input of first data indicative of the reasonableness of the business operator;
processing the first data thereby to define an operator reasonableness score;
accepting input of second data indicative of past performance of the business operator;
accepting input of third data indicative of performance of one or more comparison benchmarks;
processing the second data and third data thereby to define an operator performance comparison score;
accepting input of fourth data indicative of rental data for one or more comparison businesses;
processing the fourth data thereby to define a rental range;
determining a position in the rental range appropriate for the property to be rented by the business operator from the landlord based on the operator reasonableness score and operator performance comparison score.

2. A method for according to claim 1 including:
inputting fifth data indicative of the reasonableness of the landlord;
processing the fifth data thereby to define a landlord reasonableness score;
wherein determining the position in the rental range appropriate for the property to be rented by the business operator from the landlord is based on the operator reasonableness score, operator performance comparison score, and landlord reasonableness score.

3. A method according to claim 2 wherein the fifth data is indicative of the performance of a retail centre including the property, and/or one or more other businesses in the retail centre, relative to a set of benchmarks.

4. A method according to claim 1 wherein the position in the rental range is defined by a range.

5. A method according to claim 1 wherein the accepted data is normalised using one or more normalising parameters.

6. A method according to claim 5 wherein the one or more normalising parameters include floorspace.

7. A method according to claim 1 wherein the first data is indicative of the performance of the business operator in one or more other businesses.

8. A method according to claim 1 wherein the first data is indicative of the performance of the business operator's business in one or more other business locations.

9. A method according claim 1 wherein the third data is indicative of the performance of one or more comparison business similar to the business of the business operator in terms of any one or more of the following:
category of business;
location of business; and
characteristics of retail trading area or a shopping centre centre.

10. A method according to claim 1 wherein the rental range is defined in accordance with a plurality of dimensions, wherein the dimensions are defined in terms of any one or more of the following:
rent per square metre;
the total annual rent
rent as a percentage of turnover/sales; and
rent as a percentage of sales.

11. A method according to claim 1 wherein the rental range is defined by data renderable as one or more charts.

12. A method according to claim 11 wherein the position in the rental range is displayed relative to the one or more graphs.

13. A computer implemented method for providing rental valuation data for a property to be rented by a business operator from a landlord, the method including:
(a) accepting as input data indicative of historical business performance of the operator at the property;
(b) accepting as input data indicative of the historical business performance of the operator at one or more other properties;
(c) in the case that the historical business performance of the operator at the property is better than the historical business performance of the operator at one or more other properties, defining a parameter favourable to a higher valuation; and
(d) in the case that the historical business performance of the operator at the property is worse than the historical business performance of the operator at one or more other properties, defining a parameter favourable to a lower valuation.

14. A computer implemented method for providing feasibility data for a property to be rented by a business operator from a landlord, the method including:
accepting input of first data indicative of the predicted reasonableness of the business operator;
processing the first data thereby to define an operator reasonableness score;
accepting input of second data indicative of predicted performance of the business operator;
accepting input of third data indicative of performance of one or more comparison benchmarks;
processing the second data and third data thereby to define an operator performance comparison score;
accepting input of fourth data indicative of proposed rental costs for the property;
determining a relationship between the proposed rental costs and a feasible range appropriate for the property to be rented by the business operator from the landlord based on the operator reasonableness score and operator performance comparison score.
